(19) United States
(12) Patent Application Publication
(10) Pub. No.: US 2009/0127008 A1
(43) Pub. Date: May 21, 2009

(54) Hybrid Conversion Kits And Methods

(76) Inventor: Scott Daniel Batdorf, Raymond, OH (US)

Correspondence Address: ULMER & BERNE, LLP;ATTN: DIANE BELL, 600 VINE STREET, SUITE 2800, CINCINNATI, OH, 45202, US

(21) Appl. No.: 11/942,956

(22) Filed: Nov. 20, 2007

(51) Int. Cl. B60K 6/22; B60K 6/42; B23P 17/00; B60R 27/00

(52) U.S. Cl. 180/11; 296/203.04; 903/951; 29/401.1

(57) ABSTRACT

A hybrid conversion kit is configured for attachment to a pre-existing vehicle. The kit includes a frame assembly, an auxiliary wheel, a generator/motor, an energy storage device, and a controller. The frame assembly is adapted to be connected to the vehicle. The auxiliary wheel is mounted to the frame assembly and is positioned to contact a ground surface. The generator/motor is connected to the auxiliary wheel. The controller is configured to direct energy from the energy storage device to the generator/motor and thence to the auxiliary wheel when a vehicle is accelerating or moving at a constant, non-zero speed. The controller is further configured for causing the generator/motor to convert rotary motion of the auxiliary wheel into a different form of energy and to cause the energy so converted to be stored in the energy storage device as a vehicle decelerates. Methods are also provided.

### TECHNICAL FIELD

Kits and methods are provided for converting a pre-existing vehicle into a hybrid vehicle.

### BACKGROUND

Conventional vehicles such as cars and trucks are powered by internal combustion engines. Such internal combustion engines provided in cars often consume gasoline and operate on the Otto cycle. Some trucks and some cars include internal combustion engines which consume diesel fuel and operate on the Diesel cycle. In vehicles powered by internal combustion engines, the engine is used to accelerate and maintain the vehicle's speed, while deceleration is achieved by using friction brakes and/or engine braking (i.e., the engine with a closed throttle). Conventional vehicles have no way to capture the energy dissipated by the brakes or the engine. Accordingly, the kinetic energy lost during deceleration is converted to heat and given up to the air.

More recently, hybrid vehicles have been developed. These vehicles may have a battery pack, an electric motor, and a relatively smaller internal combustion engine. The electric motor, at times (e.g., during acceleration of the vehicle), cooperates with the internal combustion engine to produce torque for driving the vehicle's wheels. At other times (e.g., during deceleration), the electric motor becomes a generator of electricity, and the electricity so generated is stored in the battery pack. Thus, at least some of the kinetic energy given up during deceleration is stored as electro-chemical energy in the battery pack.

These conventional hybrid systems hold out the prospect of increased efficiency and economy and decreased operating costs as well as decreased environmental pollution. However, they are generally available only on vehicles designed from the ground up as hybrid vehicles.

### SUMMARY

In accordance with one embodiment, a hybrid conversion kit is configured to attach to a pre-existing vehicle. The kit comprises a frame assembly, an auxiliary wheel, a generator/motor, an energy storage device, and a controller. The frame assembly is adapted to be connected to a vehicle. The auxiliary wheel is mounted to the frame assembly and is positioned to contact a ground surface. The generator/motor is connected to the auxiliary wheel. The controller is configured to direct energy from the energy storage device to the generator/motor and thence to the auxiliary wheel when a vehicle is accelerating or moving at a constant, non-zero speed. The controller is further configured for causing the generator/motor to convert rotary motion of the auxiliary wheel into a different form of energy and to cause the energy so converted to be stored in the energy storage device as a vehicle decelerates.

In accordance with another embodiment, a method is provided of converting a pre-existing vehicle with an internal combustion engine to one capable of hybrid operation. The method comprises providing a frame assembly adapted to be connected to the vehicle. The frame assembly supports an auxiliary wheel positioned to contact a ground surface. A generator/motor, an energy storage device, and a controller are also provided. The generator/motor is connected to the auxiliary wheel. The controller is connected to the energy storage device and to the generator/motor to direct energy from the energy storage device to the generator/motor and thence to the auxiliary wheel when the vehicle is accelerating or moving at a constant, non-zero speed and for causing the generator/motor to convert rotary motion of the auxiliary wheel into a different form of energy and to cause the energy so converted to be stored in the energy storage device as the vehicle decelerates.

### BRIEF DESCRIPTION OF DRAWINGS

It is believed that certain embodiments will be better understood from the following description taken in conjunction with the accompanying drawings in which:

FIG. 1 is a schematic side elevational view of a vehicle equipped with a hybrid conversion kit in accordance with one embodiment;

FIG. 2 is a schematic top plan view of the hybrid conversion kit apart from the vehicle of FIG. 1;

FIG. 3 is a schematic view of a hybrid conversion kit in accordance with an alternative embodiment;

FIG. 4 is a schematic illustration of a hybrid conversion kit in accordance with yet another embodiment; and

FIG. 5 is a schematic illustration of a hybrid conversion kit in accordance with still another embodiment.

### DETAILED DESCRIPTION

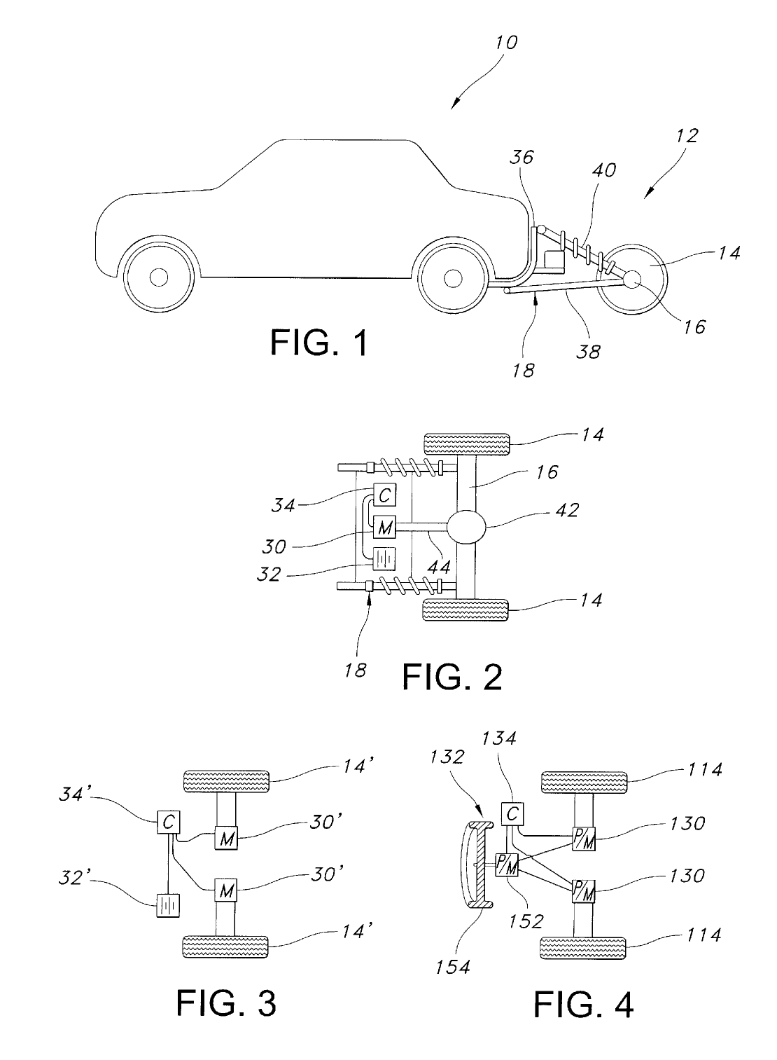

Referring to the figures in detail, wherein like numerals indicate similar elements throughout the views, FIG. 1 illustrates a vehicle 10 equipped with a hybrid conversion kit 12 in accordance with one embodiment. The hybrid conversion kit 12 may facilitate hybrid operation of the vehicle 10. It will be appreciated that the hybrid conversion kit may supplement either a hybrid or non-hybrid vehicle to improve vehicle performance (e.g., vehicle's fuel economy, load carrying capacity, stability). A hybrid conversion kit can accordingly be added to a pre-existing, non-hybrid, vehicle as an aftermarket modification of the vehicle, and in order that the vehicle may exhibit advantages of a hybrid vehicle.

The hybrid conversion kit 12 is shown in FIGS. 1-2 to include auxiliary wheels 14, an axle 16, and a frame assembly 18. It will be appreciated that the hybrid conversion kit 12 can be attached to a vehicle (e.g., as illustrated in FIG. 1) to supplement the load-carrying and/or power producing capacity of the vehicle's existing drivetrain. The hybrid conversion kit 12 may be mounted to the vehicle 10 permanently or with fittings that facilitate selective electrical and mechanical connection of the hybrid conversion kit 12 to the vehicle 10.

The frame assembly 18 is shown to include a support member 36. The support member 36 may be rigidly connected to the vehicle 10. The details of the connection to the vehicle 10 may vary according to the type and configuration of the vehicle. In one example, a vehicle may be equipped with a trailer hitch having a square socket. The support member 36 may be equipped with a corresponding square shaft for insertion into the socket. In another example, a vehicle may not be equipped with a trailer hitch. Accordingly, the support member 36 may be fashioned to be rigidly connected to other appropriate components of the vehicle which will vary from vehicle to vehicle. While the hybrid conversion kit 12 is shown to be attached to a rearward end of the vehicle 10, it will be appreciated that a hybrid conversion kit might alternatively be attached to another portion of a vehicle.

The frame assembly 18 may also include a swing arm 38 and shock absorber assembly 40. A forward end of the swing arm 38 may be pivotably connected to the support member 36. A rearward end of the swing arm 38 may be pivotably connected to the axle 16. The shock absorber assembly 40 may include a spring and damper assembly much like that used at the rear of a conventional motorcycle. The shock absorber assembly 40 can maintain contact between the auxiliary wheels 14 and a ground surface (e.g., a roadway), even when the ground surface is uneven. It will be appreciated that the shock absorber assembly may comprise any of a variety of other suitable arrangements such as might involve leaf springs, torsion bars, friction dampers, or the like.

It will also be appreciated that the shock absorber assembly 40 may comprise a selectively actuatable suspension that can change the force applied to the auxiliary wheels 14. For example, the shock absorber assembly may include a fillable chamber which can be selectively pressurized with a fluid (e.g., air). Fluid added to the chamber may extend the shock absorber and thereby increase the preload on the shock absorber assembly to produce a larger downward force on auxiliary wheels 14 (e.g., increase the traction between the wheels 14 and the ground surface). In another example, the shock absorber assembly may comprise a lift to selectively remove the auxiliary wheel from contact with the ground. Such lift may comprise a mechanical link (e.g., a toggle lever, hydraulic cylinder, and/or screw jack) in parallel with the shock absorber assembly 40.

The hybrid conversion kit 12 may further include a generator/motor and an energy storage device. The generator/motor may be engaged with at least one wheel (e.g., 14) of the hybrid conversion kit 12 and can also be connected to the energy storage device. During operation, energy may be provided from the energy storage device to the generator/motor for providing power to the wheels (e.g., 14), such as when propelling the vehicle 10. Additionally, mechanical energy (e.g., rotational energy provided during regenerative braking) may be provided from the wheels (e.g., 14) to the generator/motor for providing energy for storage in the energy storage device.

In one embodiment, as illustrated in FIG. 2, the generator/motor may comprise an electric motor 30 and the energy storage device may comprise a battery 32. The battery 32 may be electrically connected to the electric motor 30 and the electric motor 30 may be mechanically connected to one or more of the wheels 14 (e.g., through the drive shaft 44 and the differential 42). During operation, electrical energy may be provided from the battery 32 and to the electric motor 30 so that the electric motor 30 may provide mechanical energy to the wheels 14. Alternatively, mechanical energy may be provided from the wheels 14 to the electric motor 30 so that the electric motor 30 can provide electrical energy for storage within the battery 32.

In another embodiment, as illustrated in FIG. 3, a hybrid conversion kit may comprise two electric motors 30′ and a battery 32′. The battery 32′ may be electrically connected to each of the electric motors 30′ and the electric motors 30′ may be respectively mechanically connected to the wheels 14′. During operation, electrical energy may be provided from the battery 32′ and to the electric motors 30′ so that the electric motors 30′ may provide mechanical energy to the wheels 14′. Alternatively, mechanical energy may be provided from the wheels 14′ to the electric motors 30′ so that the electric motors 30′ can provide electrical energy for storage within the battery 32′.

In yet another embodiment, as illustrated in FIG. 4, a hybrid conversion kit may comprise two pump/motors 130 and a hydraulic storage device 132. The hydraulic storage device 132 may comprise a flywheel 154 connected to a pump/motor 152. The hydraulic storage device 132 may be hydraulically connected to each pump/motor 130 and each pump/motor 130 may be mechanically connected to each wheel 114. During operation, mechanical energy may be provided from the flywheel 154 to the pump/motor 152, and the pump/motor 152 may provide hydraulic energy to each pump/motor 130 to power the wheels 114. Alternatively, mechanical energy may be provided from the wheels 114 to each pump/motor 130, and each pump/motor 130 may provide hydraulic energy to the pump/motor 152 to power the flywheel 154.

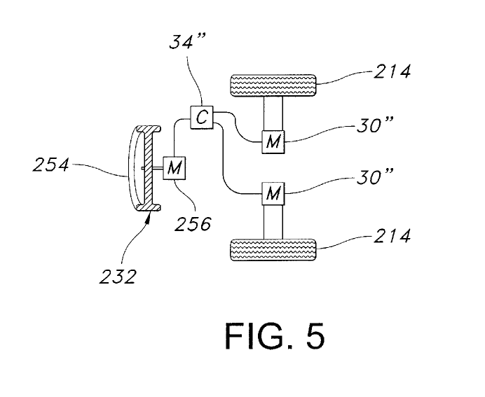

In yet another embodiment, as illustrated in FIG. 5, a hybrid conversion kit may comprise two electric motors 30″ and an energy storage device 232. The energy storage device 232 may comprise a flywheel 254 connected to an electric motor 256. The energy storage device 232 may be electrically connected to each electric motor 30″, and each electric motor 30″ may be respectively mechanically connected to each wheel 214. During operation, mechanical energy may be provided from the flywheel 254 to the electric motor 256, and the electric motor 256 may provide electric energy to each electric motor 30″ to power the wheels 214. Alternatively, mechanical energy may be provided from the wheels 214 to each electric motor 30″, and the electric motor may provide electric energy to the electric motor 256 to power the flywheel 254. It will therefore be appreciated that an energy storage device can comprise any of a variety of arrangements for storing and delivering energy. It will also be appreciated that a generator/motor can comprise any of a variety of arrangements which can be operated between a first mode in which the generator/motor converts energy from an energy storage device into rotational energy and a second mode in which the generator/motor converts rotational energy into energy for storage in an energy storage device.

The hybrid conversion kit 12 may further comprise a controller. As is common, the controller may facilitate operation of the hybrid conversion kit 12 by monitoring vehicle conditions, the generator/motor, and/or the energy storage device, and then operating the generator/motor(s) and/or storage devices accordingly. It will be appreciated that the controller may comprise any of a variety of devices capable of receiving inputs and operating a generator/motor and/or energy storage device. It will also be appreciated that the controller may be configured to facilitate control of certain types of generator/motors and/or energy storage devices. For example, as illustrated in FIGS. 2 and 3, a controller (e.g., 34, 34′) may be configured to facilitate control of an electric motor (e.g., 30, 30′) and battery (e.g., 32, 32′). In another example, as illustrated in FIG. 4, a controller 134 may be configured to facilitate control of two pump/motors 130 and a hydraulic storage device 132. In yet another example, as illustrated in FIG. 5, a controller 34″ may be configured to facilitate control of two electric motors 30″ and an energy storage device 232.

Any of a variety of inputs may be provided to a controller to indicate various conditions of a hybrid conversion kit and associated vehicle. In one embodiment, an input may be provided to the controller to indicate the amount of energy stored in the energy storage device (e.g., the voltage of the battery 32). In another embodiment, an input may be provided to the controller to indicate the position of the vehicle's throttle (e.g., indicative of the desired power output). In such an embodiment, the controller may compute the first and second derivatives of the throttle position to more smoothly and accurately determine the driver's intention for vehicle performance. For example, if the first derivative is negative, the generator/motor may draw energy from the wheels and store it in the energy storage device.

In one embodiment, one or more inputs may be provided to the controller to indicate the performance of an internal combustion engine in the vehicle 10 (e.g., engine speed, output torque, operating temperature, intake manifold vacuum). Input(s) may additionally be provided to the controller to indicate the performance of the vehicle's braking system (e.g., depression of brake pedal and/or activation of brake lights). In another embodiment, an input may be provided to the controller to indicate a user input. For example, such an input may indicate whether a user wishes to activate/deactivate the hybrid conversion system and/or to adjust the level of driving torque provided by the hybrid conversion kit.

The battery 32, the electric motor 30, and the controller 34 are shown in FIG. 2 to be mounted on the support member 36. In this configuration, it will be appreciated that these components can be isolated from road shock and vibration and can avoid imposing significant weight upon the vehicle's pre-existing suspension system. However, it will be appreciated that an energy storage device and controller may be mounted in any of a variety of other suitable locations, whether adjacent to or disposed remotely from the wheel(s) and/or generator/motor(s) of a hybrid conversion kit.

It will be appreciated that a hybrid conversion kit may increase the efficiency and operation of a vehicle. For example, during operation of the vehicle, the hybrid conversion kit may, at times, assist or operate in lieu of the vehicle's engine in propelling the vehicle such as when the vehicle rapidly accelerates, encounters an increased grade, or the like. Additionally, the hybrid conversion kit may facilitate recovery of energy lost during braking. In one embodiment, when the vehicle brakes, the hybrid conversion kit may resist rotation of its wheels through regenerative braking. Such regenerative braking may provide energy to the energy storage device. The additional energy in the energy storage device may permit the generator/motor to later provide power to the wheels, thereby assisting or reducing reliance upon the vehicle's engine.

Although the hybrid conversion kit is illustrated in connection with an automobile, it will be appreciated that the hybrid conversion kit can be readily arranged for other vehicles, such as trucks, ATVs, motorcycles and even bicycles. The hybrid conversion kit may increase the capacity of the vehicle to carry additional load as well as increase the total permissible weight of the vehicle. In another example, a hybrid conversion kit may be attached to an ATV. The hybrid conversion kit may increase the capacity of the ATV to carry increased load as well as provide additional cargo space (e.g., a cargo box secured to the hybrid conversion kit). Although the hybrid conversion kit 12 has been described as having two auxiliary wheels, it will be appreciated that the hybrid conversion kit may comprise any of a variety of wheel configurations. For example, a hybrid conversion kit can comprise a single wheel suitable for use with a car, motorcycle or even a bicycle. As a hybrid conversion kit includes its own wheel(s) for contacting a ground surface, it will be appreciated that attachment of the hybrid conversion kit to a pre-existing vehicle can be quick and simple, as no connection is required between the hybrid conversion kit and the drivetrain or wheels of the pre-existing vehicle.

In view of the foregoing, it is clear that the present disclosure teaches how to add the benefits of a hybrid drive train to a pre-existing, non-hybrid vehicle, and without requiring any aftermarket connection to the drivetrain of the vehicle. The hybrid conversion kit includes an auxiliary wheel or wheels and a frame assembly to connect the auxiliary wheel(s) to the vehicle. The auxiliary wheel is connected to a motor/generator. The hybrid conversion kit also includes an energy storage medium such as a battery or a flywheel that, at times, directs stored energy to the motor/generator and, at other times, stores energy extracted from the auxiliary wheel(s).

The foregoing description of embodiments and examples has been presented for purposes of illustration and description. It is not intended to be exhaustive or to limit the invention to the forms described. Numerous modifications are possible in light of the above teachings. Some of those modifications have been discussed and others will be understood by those skilled in the art. The embodiments were chosen and described in order to best illustrate certain principles and various embodiments as are suited to the particular use contemplated. The scope of the invention is, of course, not limited to the examples or embodiments set forth herein, but can be employed in any number of applications and equivalent devices by those of ordinary skill in the art. Rather it is hereby intended the scope of the invention be defined by the claims appended hereto.

What is claimed is:

1. A hybrid conversion kit configured to attach to a pre-existing vehicle, said kit comprising:
a frame assembly adapted to be connected to a vehicle;
an auxiliary wheel mounted to the frame assembly and positioned to contact a ground surface;
a generator/motor connected to the auxiliary wheel;
an energy storage device; and
a controller configured to direct energy from the energy storage device to the generator/motor and thence to the auxiliary wheel when a vehicle is accelerating or moving at a constant, non-zero speed and for causing the generator/motor to convert rotary motion of the auxiliary wheel into a different form of energy and to cause the energy so converted to be stored in the energy storage device as a vehicle decelerates.

2. The hybrid conversion kit of claim 1 wherein the energy storage device is configured to store electrical energy and the generator/motor comprises an electric motor.

3. The hybrid conversion kit of claim 1 wherein the energy storage device is configured to store mechanical energy and the generator/motor is configured to be fluid operated.

4. The hybrid conversion kit of claim 1 wherein the energy storage device is configured to store mechanical energy and the generator/motor comprises an electric motor.

5. The hybrid conversion kit of claim 1 including two auxiliary wheels.

6. The hybrid conversion kit of claim 5 wherein each of the two auxiliary wheels is connected to the same generator/motor.

7. The hybrid conversion kit of claim 5 further including a separate generator/motor, wherein each of the two generator/motors is connected with a respective of the two auxiliary wheels.

8. The hybrid conversion kit of claim 7 wherein the energy storage device is configured to store electrochemical energy.

9. The hybrid conversion kit of claim 8 wherein the energy storage device comprises a battery.

10. The hybrid conversion kit of claim 3 wherein the energy storage device comprises a flywheel.

11. The hybrid conversion kit of claim 1 wherein the frame assembly is configured to be rigidly connected to a vehicle and includes a suspension, the suspension being configured to urge the auxiliary wheel toward a ground surface.

12. The hybrid conversion kit of claim 11 wherein the suspension includes a shock absorber assembly.

13. The hybrid conversion kit of claim 11 wherein the suspension assembly includes means for varying the force with which the auxiliary wheel is urged toward a ground surface.

14. A method of converting a pre-existing vehicle with an internal combustion engine to one capable of hybrid operation, said method comprising:
providing a frame assembly adapted to be connected to the vehicle, the frame assembly supporting an auxiliary wheel positioned to contact a ground surface;
providing a generator/motor connected to the auxiliary wheel;
providing an energy storage device; and
providing a controller connected to the energy storage device and to the generator/motor to direct energy from the energy storage device to the generator/motor and thence to the auxiliary wheel when the vehicle is accelerating or moving at a constant, non-zero speed and for causing the generator/motor to convert rotary motion of the auxiliary wheel into a different form of energy and to cause the energy so converted to be stored in the energy storage device as the vehicle decelerates.

15. The method of claim 14 wherein providing an energy storage device comprises providing a battery, and wherein providing a generator/motor comprises providing an electric motor.

16. The method of claim 14 wherein providing an energy storage device comprises providing a device configured for storing mechanical energy.

17. The method of claim 16 wherein providing the device for storing mechanical energy comprises providing an electric motor connected to a flywheel.

18. The method of claim 16 wherein providing the device for storing mechanical energy comprises providing a hydraulic generator/motor connected to a flywheel.

19. The method of claim 14 wherein providing the frame assembly comprises the frame assembly supporting two auxiliary wheels.

20. The method of claim 19 wherein providing the generator/motor comprises providing at least two separate generator/motors, respective ones of said generators/motors being connected to respective ones of the auxiliary wheels.

21. The method of claim 19 wherein providing the generator/motor comprises connecting the generator/motor to both of the two auxiliary wheels.

22. The method of claim 14 further comprising providing a suspension assembly to resiliently bias the auxiliary wheel against a ground surface.
